(19) United States
(12) Patent Application Publication
(10) Pub. No.: US 2010/0127430 A1
(43) Pub. Date: May 27, 2010

(54) Spray system having a dosing device for a molding process

(76) Inventor: Gurdeep Singh, Kalamazoo, MI (US)

Correspondence Address: FLYNN THIEL BOUTELL & TANIS, P.C., 2026 RAMBLING ROAD, KALAMAZOO, MI, 49008-1631, US

(21) Appl. No.: 12/592,010

(22) Filed: Nov. 18, 2009

Related U.S. Application Data
(60) Provisional application No. 61/199,980, filed on Nov. 22, 2008.

(51) Int. Cl. B28B 7/38

(52) U.S. Cl. 264/338; 425/90

(57) ABSTRACT

A spray system for a molding process applies mold release agent to a surface of a mold to assist in release of a molded article from the mold. The spray system includes a spray head attached to a frame member. The spray head is vertically movable with respect to the frame member. The spray head includes a plurality of nozzles for outputting mold release agent. A mold release agent source provides mold release agent to a mold release dosing device. The dosing device provides select quantities of mold release agent through a conduit to a manifold mounted on the spray head. The manifold includes a plurality of valves leading to a plurality of nozzles. Then the dosing device outputs a predetermined amount of mold release agent to the manifold through the conduit. In operation, the spray system provides an air input to the dosing device to remove any mold release agent therefrom and to flush mold release agent from the conduit and manifold outwardly through the nozzles. Thus, a precise quantity of mold release agent is obtained in the dosing device and provided to a surface of a mold.

### CROSS REFERENCE TO RELATED APPLICATION

This application claims the benefit of U.S. Provisional Application Ser. No. 61/199 980, filed Nov. 22, 2008, which is incorporated herein by reference in its entirety.

### FIELD OF THE INVENTION

This invention is related generally to a spray system including a dosing device for applying a predetermined amount of release agent to predetermined regions of a mold in order to provide a more uniform amount of release agent on a mold surface.

### BACKGROUND OF THE INVENTION

The molding of parts, such as for use in automobiles is well known. One example of molding includes the steps of opening a mold, applying a release agent thereto, and closing the mold while providing a molding material, such as a heated stream including magnesium inside the mold.

One known spray system for applying a release agent within a mold includes a guide shaft unit having a guide shaft vertically movable so that a lower end thereof can be introduced within a mold that is in an open position. The lower end of the guide shaft includes a spray head with nozzles for applying a release agent combined with an air pressure flow onto surfaces of a mold. The spray head has a separate set of air blow nozzles for applying air to spread the release agent on the mold surfaces.

Such known spray systems further include an up pressure valve, a down pressure valve and a pressure adjustment mechanism for applying pneumatic air to move the guide shaft upwardly or downwardly. The spray system also receives pneumatic air pressure from a compressor that is utilized to provide pressure to an up pressure valve or a down pressure valve for moving the spray unit upwardly or downwardly. The valve arrangement can control the speed and amount of movement upwardly or downwardly for the guide shaft.

Further, the guide shaft unit includes a spray situation adjustment screw for controlling the amount of spray applied by the spray system.

The spray system includes a spray unit that receives release agent from a container or other source via a conduit that includes a spray adjustment screw. The spray unit includes a master valve for introducing air into the spray unit. Release agent simply passes through a liquid valve to a manifold or a spray head that receives both release agent via the liquid valve and air traveling through the master valve to apply the release agent to a user.

The pneumatic pressure is supplied to the spray unit and advanced to the manifold, along with a release agent for providing a mold release. The release agent and air combine in the manifold and are output by spray nozzles of the spray head onto a mold. The pressurized air exiting the nozzle has a vacuum effect on the mold release agent in a conduit providing the mold release agent to the manifold. Thus there is a delay in the output of mold release agent from the nozzles of the spray unit.

Finally, pneumatic air is provided to an air blow valve for selectively applying air through additional air blow nozzles to a previously applied release agent disposed at a lower end of the movable spray unit to apply air to spread the release agent throughout the mold.

Due to a number of factors, accuracy for the quantity of release agent applied to a mold is difficult to obtain, much less predict. One factor is a significant distance between the liquid valve for the release agent and the location of the spray head nozzle. A large quantity of release agent is provided in the connecting line between the valve and spray head. The amount of the release agent that remains in the line or is output through the spray nozzles by a Venturi effect is not predictable. Thus, the amount of release agent applied to a mold can differ significantly and is unpredictable.

Another factor affecting accuracy of the release agent, when multiple spray units are provided sharing the same pneumatic air source. Depending on the predetermined operating times for the multiple spray units, the pressure output values from a compressor air source can vary and thus vary the pressure applied to force a mold release agent. His factor may result in improper quantities out a spray nozzle.

In this known arrangement, the amount of pressure of the mold release agent and the time that the liquid valve is open, along with the pressure valve of the air provided by the air blow valve, result in variation of the quantity of release agent applied from the spray head.

As to other factors, fluid pump pressure of the mold release agent, air pump pressure of a compressor, the opening and closing times of valves for air, for control and for operation of a valve for a mold release, and even adjustable nozzle flow settings are all inexact factors that may lead to inaccuracy in the amount of mold release agent applied to a mold.

An object of the invention is to provide a spray system wherein an exact dosage of release agent is applied to a mold at each application cycle.

Another object of the invention is to reduce the sticking of parts formed within the mold due to a lack of mold release agent thereon. Further, the proper amount of mold release enables better flow of casting material within the die and results in a more constant temperature or temperature range within the die to more uniformly provide a predetermined cooling effect for the die that prevents overcooling or overheating, which wears a die or mold prematurely.

Another object of the invention is to minimize energy use, such as by generally not requiring a separate blow off process utilizing the separate blow off nozzle. Further, the amount of noise is reduced by Applicant's claimed invention.

Another object of the invention that is obtained by sharing the same nozzles for applying release agent and air is that the air is sprayed exactly where the mold was applied to improve the spreading of the mold onto the mold surfaces. Besides magnesium, zinc and aluminum, there are other metals that can be used in die cast molding embodiments.

Another object of the invention is to ensure that the mold release pump pressure and mold release timing for applying release agent from a nozzle are not critical to the amount or dose of release agent applied therefrom.

In one embodiment, a dosing device is mounted to the movable spray unit to minimize the length of a connecting line between the dosing unit and the spray head thereof.

In another embodiment of the invention, air is provided through the mold release agent connecting line to remove essentially all release agent from the conduit and to apply same onto the mold.

In another embodiment of the invention, the speed/cycle time for operation of the spray unit and molding device is improved.

Another embodiment of the invention provides the proper amount of mold release to the inner surface of a mold so that, for example, in the instance of a die cast material including magnesium, little fluid is left over in the mold, which prevents magnesium from exploding due to the over saturation of the die with a mold release.

The embodiments that include flushing or removing release agent from the fluid line connected to the spray heads lead to improved accuracy, and better conditioning of the flow line, as air is blown through the same nozzles that apply the release agent.

Some of the embodiments utilize reaction injection molding (RIM), but the claimed invention may be utilized to apply a release agent to cooking molds used in commercial bakeries or to other areas that require application of an even amount release agent.

### BRIEF DESCRIPTION OF THE DRAWINGS

FIG. 1 is a perspective view showing one embodiment of a spray system including vertically movable spray head having a dosing device.

FIG. 2 is a perspective view showing a view of a mold release spray system provided in a position above a die cast machine.

FIG. 3 shows a pneumatic diagram of the spray system including a dosing device, along with a spray manifold and a blow off manifold.

FIG. 4 is a block diagram of an electronic control circuit of the invention.

FIG. 5 is a flow chart showing an operation of the spray system.

FIG. 6 is a flow chart describing a release agent spray subroutine for the dosing device that is illustrated in FIG. 3.

FIG. 7 is a cross-sectional view of a dosing quantity meter device.

Certain terminology will be used in the following description for convenience and reference only, and will not be limiting. For example, the words “upwardly”, “downwardly”, “rightwardly” and “leftwardly” will refer to directions in the drawings to which reference is made. The words “inwardly” and “outwardly” will refer to directions toward and away from, respectively, the geometric center of the arrangement, and designated parts thereof. Said terminology includes the word specifically mentioned, derivatives thereof, and words of similar input.

### DETAILED DESCRIPTION

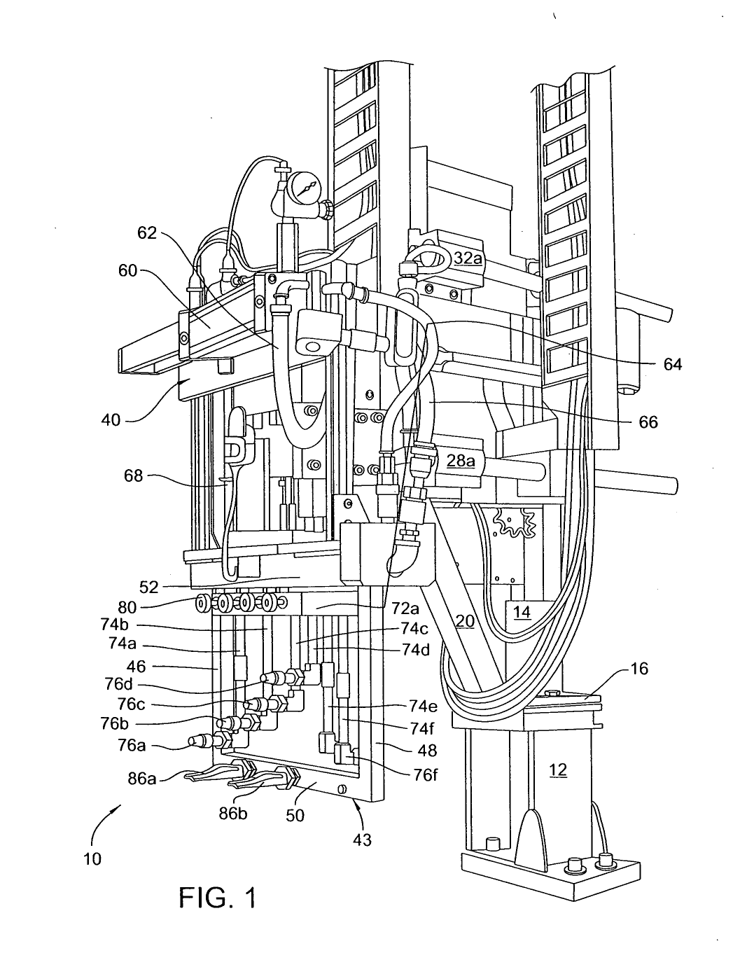

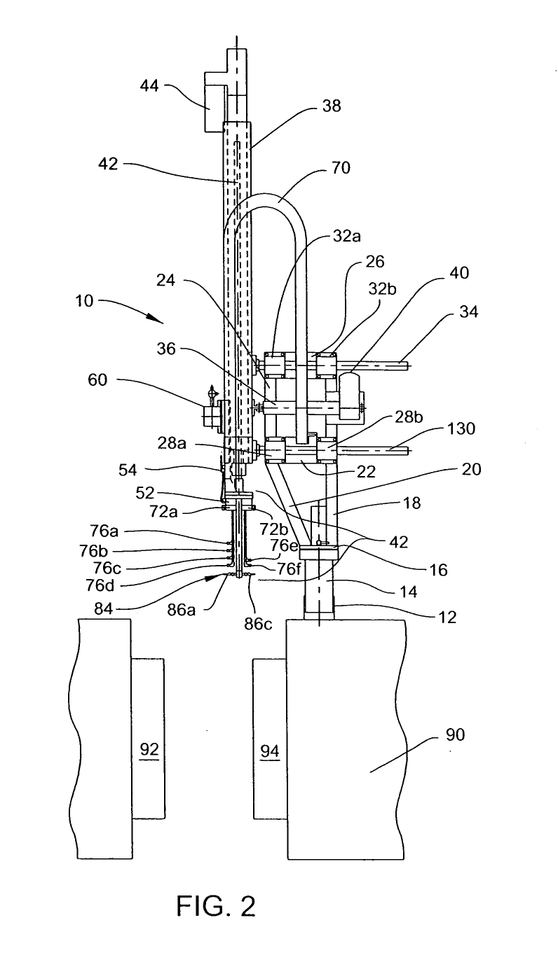

FIGS. 1 and 2 depict a spray system 10 of the invention. Spray system 10 is designed to provide a precise coating of a release agent to inner surfaces of molds to enable release of a molded object therefrom after completion of a molding process.

The spray system 10 includes a support structure for securing the system onto a floor. The support structure of the spray system 10 includes a fixed mount 12 and a pivoting base 14 disposed thereon that is rotatable relative to the mount 12 about an upwardly oriented axis. The support structure further includes a plate 16 that is pivotable along with the base 14. The plate 16 has mounted thereon a vertically oriented support 18 and has an angled support 20 secured thereto.

As shown in FIG. 2, the support structure of the spray system 10 includes a horizontal support 22 joined between an end of the angled support 20 and a midsection of the support 18. A front vertically oriented support element 24 extends upwardly from the distal end of the angled support 20. An upper horizontal support member 26 joins the top end of front support 24 to an upper end of support 18. Lower horizontal support bushings 28a, 28b are provided horizontally spaced and opening in alignment with each other. A lower horizontal travel guide shaft 30 extends through the pair of bushings. Upper horizontally spaced travel support bushings 32a, 32b receive an upper horizontal guide shaft 34. A horizontally oriented driving shaft 36 is disposed in parallel with and between the lower and upper horizontal guide shafts 30, 34. Proximal ends of the guide shafts 30, 34 and the driving shaft 36 are affixed to frame member 38. A horizontal linear actuator 40 coacts with the driving shaft 36 for horizontally extending and retracting the driving shaft along the length thereof. Thus the driving shaft 36 moves the fixed frame member 38 horizontally relative to the mounting structure, including the mount 12 and pivotable base 14.

The frame member 38 receives a vertically movable frame 42 that is supported thereon. As shown in FIG. 1, the vertically movable frame 42 includes a spray head 43 mounted at a bottom edge thereof. A vertical linear actuator 44 moves the vertically movable frame 42 and thus the spray head 43 upwardly and downwardly.

As shown in FIG. 1, a pair of vertically oriented legs 46, 48 joined at lower ends thereof by a cross piece 50 and joined at an upper end by upper horizontal cross piece 52 and, in combination, form the spray head 43 having a rectangular shape. A quick release mechanism 54 secures an upper part of the spray head 43 to the bottom of the movable frame 42.

Electrical power cables provide power to the linear actuators 40, 44, a dosing device 60 and other powered devices of the spray system 10.

The dosing device 60 is mounted to the upper horizontal crosspiece 52 of the spray head 43. Hoses 62, 64 provide mold release agent such as air. Hose 66 provides gas to the spray system 10. A cat track 70 illustrated in FIG. 2 carries air hoses, mold release hoses and power lines.

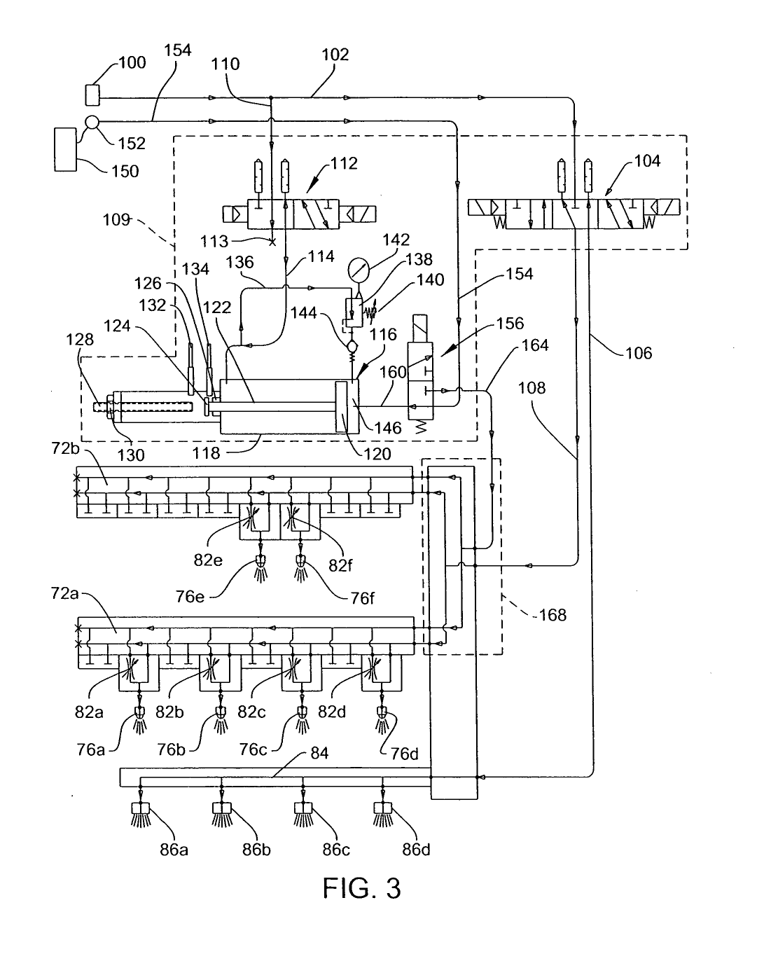

Turning to FIG. 1, the spray head includes a spray manifold 72 that receives a plurality of variable length spray nozzle elements 74a-74g. Each of the spray nozzle elements 74a-74g has a spray nozzle 76a-76g oriented horizontally at the respective lower ends thereof. A plurality of dial elements 80, shown in FIG. 1, provides manual adjustment of the respective spray valves 82a-82f illustrated in FIG. 3.

Spray manifolds 72a, 72b mounted horizontally at the top of the spray head 43 provide release agent to respective nozzle elements. Spray manifold 72a provides release agent to nozzles 76a-76d oriented in a first substantially horizontal direction. Spray manifold 72b provides release agent to nozzles 76e, 76f oriented in an opposing horizontal direction with respect to nozzles 76a-76d.

While FIG. 1 shows four nozzles 76a-76d oriented in a first horizontal direction and two nozzles 76e, 76f oriented in a second opposing substantially horizontal direction, the invention contemplates the use of any number of nozzles oriented in either direction.

Cross piece 50 at the lower end of spray head 42 contains a blow-off manifold 84 thereon. In some embodiments, the blow-off manifold 84 shown in FIG. 3 replaces the lower cross piece 50 and acts as a support element for the spray head 43. The blow-off manifold 84 includes blow-off nozzles 86a, 86b oriented horizontally outwardly therefrom as shown in FIG. 1 and blow-off nozzle 86c oriented in an opposing horizontal direction as shown in FIG. 2. In different embodiments, any number of blow-off nozzles 86 are provided and aligned in either substantially horizontal direction.

FIG. 2 illustrates molding machine 90 including a pair of mold elements 92, 94 in an open position.

FIG. 3 shows a valve arrangement and structure of dosing device 60 for providing release agent followed by air from the spray manifold 72a, 72b and providing air from the blow-off manifold 84.

Pneumatic air compressor 100 in FIG. 3 provides pressurized air through air conduit 102 to a high pressure two output air valve 104. The two output air valve 104 is capable of selectively providing pressurized air to a high pressure blow-off manifold conduit 106 or to a high pressure spray manifold output conduit 108. The high pressure blow-off manifold conduit 106 connects to the blow-off manifold 84. The high pressure spray manifold output conduit 108 connects to the release agent spray manifolds 72a, 72b as shown in FIG. 3.

Dosing device 60 is illustrated in FIG. 3 by a dosing device air and release agent circuit 109 shown in broken line. The dosing device circuit 109 includes a dosing device air conduit 110 that connects to a dosing device air feed valve 112. The air feed valve 112 includes a bleed valve 113. An air feed conduit 114 connects to a dosing quantity control unit 116 of the dosing device 60.

The dosing quantity control unit 116 includes a cylinder 118 having a piston defined by a piston head 120 and a piston shaft 122. The piston head 120 has an O-ring positioned radially outwardly about the circumference thereof to provide a seal within the chamber formed within the cylinder 118. A first end of the piston shaft 122 is secured to the piston head 120 and a second end of the piston shaft projects outwardly from a rear opening of cylinder 118. A radially outwardly extending piston stop 124 is disposed at the end of the piston shaft 122 that projects from the cylinder 118. A sealing element 126 provides a seal that isolates a chamber in the cylinder at the piston stop side of the cylinder 118 from outside areas during linear movement of piston shaft 122.

The dosing quantity control unit 116 further includes a mold release volume adjustment 128. The mold release volume adjustment 128 includes a rotatable adjustment element 130 for moving a mold release full switch 132 linearly toward or away from the piston stop 124 of the quantity control unit 116. In some embodiments, the piston stop 124 includes a magnet or other means thereon for magnetically actuating mold release full switch 132 or mold release dispensed switch 134. In some embodiments, the mold release full switch 132 and mold release dispensed switch 134 optically sense the position of the piston stop 124 as the stop moves linearly with the piston shaft 122.

The dosing device circuit 109 further includes a dosing branch air flow conduit 136 that branches from the air feed conduit 114 and opens into a pressure regulator 138 including a pressure setting element 140. Further, a pressure gauge 142 measures the air pressure thereat. An output side of the pressure regulator 138 connects to a check valve 144 that provides a flow path to a dosing side 146 of the piston head 120 within the cylinder 118. The check valve 144 prevents a flow of release agent from the chamber at the dosing side 146 to the pressure regulator 138.

A mold release source or container 150 shown in FIG. 3 provides a mold release agent driven by mold release pump 152 through mold release conduit 154. The mold release conduit connects to an input port of a mold release 3-way valve 156.

The mold release 3-way valve 156 includes an output conduit 160 that provides a fluid connection to the dosing side 146 of the dosing quantity control unit 116. The mold release 3-way valve 156 also switches and closes the port to the mold release conduit 154 and opens a separate connection to a spray head conduit 164. The spray head conduit 164 connects to the release agent spray manifolds 72a, 72b through a manifold arrangement 168 that essentially parallels the flow paths of the high pressure spray manifold output conduit 108 that connects to the spray manifolds 72a, 72b.

### Electronic Control System

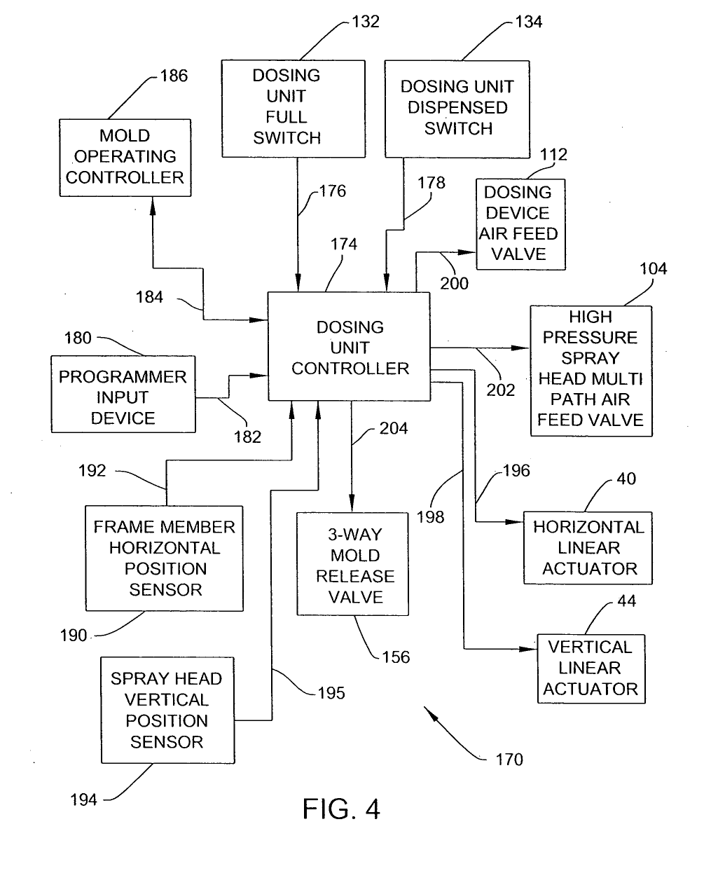

The block diagram of FIG. 4 shows the electronic control circuit 170 of the spray system 10. The electronic control circuit 170 includes a dosing unit controller 174, such as a programmable logic controller (PLC). The dosing unit controller 174 receives a plurality of inputs and provides a plurality of outputs to control the spray system 10.

Mold release agent full switch 132 and mold release agent dispensed switch 134 of the dosing quantity control unit 116 each provide an input 176, 178 to the dosing unit controller 174. Further, a programmer input device 180, such as a touchscreen or keyboard, provides an information or data input 182 to the controller 174 that includes parameters for the particular molds being utilized, parameters for the particular positions required for the spray head, parameters for the amount of spray for each of the spray nozzles, and information regarding cycle time for the spray system 10.

The dosing unit controller 174 receives an input 192 from frame member horizontal position sensor 190 and an input 195 from spray head vertical position sensor 194.

Dosing unit controller 174 communicates over signal path 184 with a molding machine controller 186. The molding machine controller 186 controls the molding machine 90 to close the mold, inject molding material into the mold, determine completion of a molding process and open the mold. The molding machine controller 186 operates the molding machine 90 in an essentially known manner.

The molding machine controller 186 and the dosing unit controller 174 communicate with each other to determine when spray system operations occur and when molding operations occur. Thus the controllers 174, 186 ensure essentially error free, fast operation of the respective machine 90 and spray system 10 for each molding cycle.

The dosing unit controller 174 provides outputs 196, 198 to the horizontal linear actuator 40 and the vertical linear actuator 44, respectively.

The dosing unit controller 174 provides a control signal output 200 to the dosing device air feed valve 112 and provides a signal output 202 to the high pressure spray head multi-path air feed valve 104. Further, the PLC 174 provides a control signal output 204 to the 3-way mold release valve 156.

As illustrated in FIG. 4, the dosing unit controller 174 receives inputs from the dosing unit switches 132, 134, from molding machine controller 186, from spray head horizontal position sensor 190, and from spray head vertical position sensor 194.

In response to the input signals, the dosing unit controller 174 then provides outputs to control the spray system 10. The dosing unit controller 174 provides control signals 196, 198 to the horizontal and linear actuators 40, 44 of the spray system 10 to move the spray head 43, along with other moveable elements fixed thereto, upwardly and/or downwardly, as well as moving the fixed frame member 38 horizontally, if necessary, in order to position the spray head 43 inside an open mold. Further, the base 14 of the support structure pivots, if necessary, for alignment of the spray head 43 with a mold.

In some embodiments, the horizontal and linear actuators 40, 44 are servomotors, such as step motors, to increase the speed and the overall position accuracy of the spray head 43 of the spray system 10. Such an arrangement increases the number of operations or shots per minute of a molding machine 90 forming molded articles.

### Spray System Operation

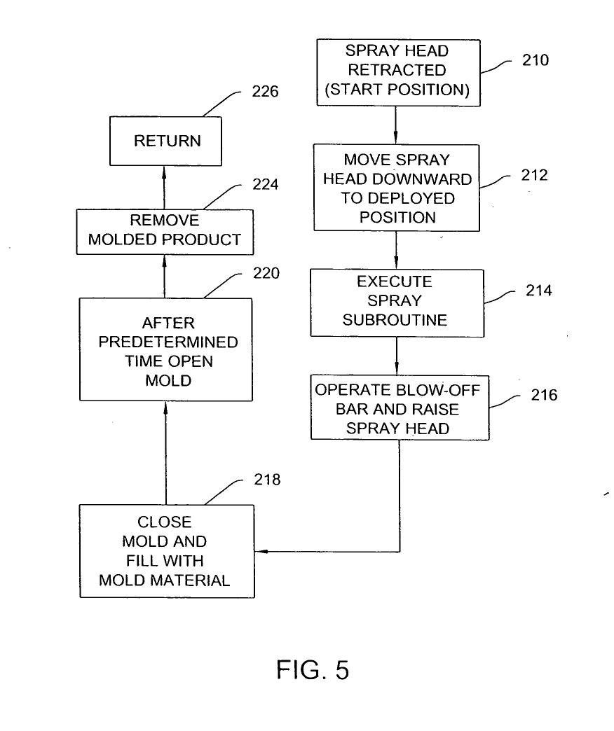

Spray system 10 is controlled by dosing unit controller 174 as follows. At step 210 in FIG. 5, the spray head 43 of the spray system 10 is in the retracted, raised position when a manufacturing cycle for obtaining a molded article begins. At step 212, dosing unit controller 174 operates the horizontal linear actuator 40 to move the frame member 38 horizontally, if necessary. Then the dosing unit controller 174 controls the vertical linear actuator 40 to move the spray head 43 downwardly to a deployed operating position.

At step 214, a spray subroutine executes to provide an exact quantity of release agent to the surface of inner walls of the mold elements 90, 92 as will be discussed below.

At step 216, air is output through blow-off nozzles 86a, 86b, 86c as the spray head 43 is raised to the retracted or stowed position shown in FIG. 2 by vertical linear actuator 44. The air provided through the blow-off nozzles 86a, 86b typically is stopped by the dosing unit controller 174 before the spray head 43 exits the region of the open mold elements 92, 94.

At step 218, the mold elements 92, 94 of the molding machine 90 close and the mold is filled with molding material. After a predetermined time, at step 222 the mold elements 92, 94 are opened by the mold operating controller 186. Then at step 224 the molded article is removed.

At step 226, a molded article process cycle is finished and the process returns to step 210 to repeat the cycle and form additional molded articles.

### Spray Subroutine

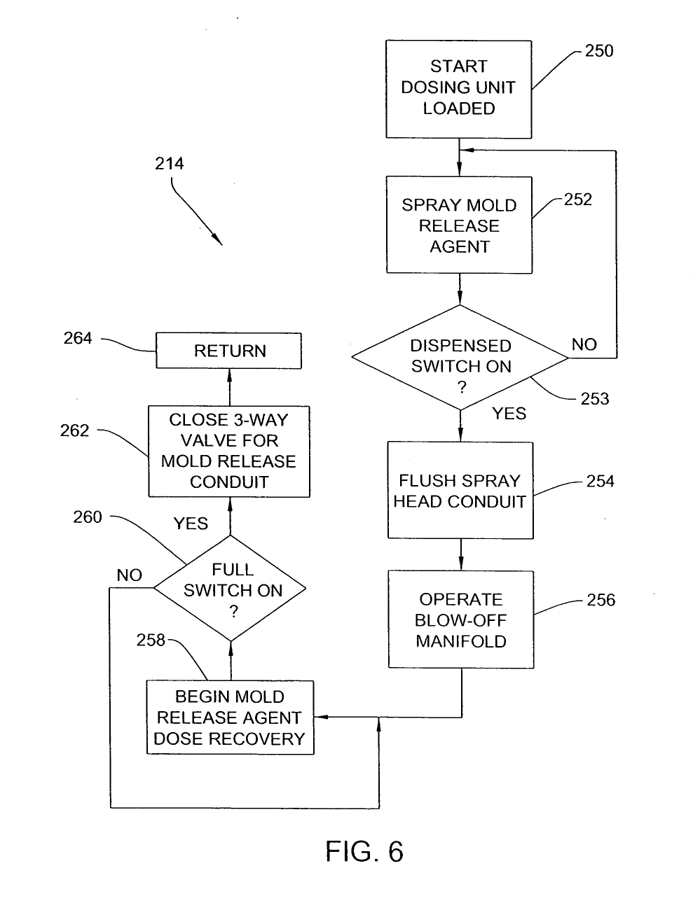

FIG. 6 shows a release agent spray subroutine of the invention. At step 250, the spray subroutine starts with the spray head in a downward deployed position between or within the mold elements.

At step 250, the dosing quantity control unit 116 is in the release agent loaded position. The piston head 120 is retracted so that the piston stop 124 is in alignment with the mold release full switch 132. The dosing side 146 of the piston head 120 is filled with mold release agent. At step 250, dosing device air feed valve 112, the high pressure two output air valve 104 and the mold release 3-way valve 156 are in closed positions.

At step 252 mold release agent is sprayed. The dosing device circuit 119 is controlled by the dosing unit controller 174 to open mold release 3-way valve 156 to provide a flow path from the dosing side 146 of the piston, through fluid output 160 and along spray head conduit 164 to the release agent spray manifold 72a, 72b. Thus, the release agent at the dosing side 146 has an open path to the spray manifold 72a, 72b. Then dosing device air feed valve 112 opens to provide high pressure air along air feed conduit 114 and into the side of the piston head 120 including the piston shaft 122. The air applied into the cylinder 118 forces the piston head 120 to move rightwardly to the position shown in FIG. 3, which forces the mold release agent from the dosing side 146 of the piston head 120 into the fluid output 160 and through the 3-way valve 156 along spray head conduit 164 to the mold release agent spray manifold 72a, 72b. The release agent then passes through the appropriate valves 82a-82f. At essentially the same time, high pressure two output valve 104 provides air through pressure spray manifold output 108 to the spray manifolds 72a, 72b. The air or gas combines with the mold release agent to form a mist that is output by the nozzles 76a-76f.

At decision step 253, the dosing unit controller 174 determines if the end of the piston shaft 122 is adjacent the dispensed switch 134 so that the switch is on, which indicates complete piston travel. If not, the spray subroutine 214 returns to step 252. When the dosing unit controller 174 senses that the dispensed switch is on, the spray subroutine 214 advances to step 254.

At mold release agent flushing step 254, the piston head 120 is in the closed position illustrated in FIG. 3. The air that closed the piston now provides a force or pressure through dosing branch air flow conduit 136 to the pressure regulator 138. The pressure regulator 138 is adjusted so that, after movement of the piston to the closed position, a flow of air passes through check valve 144 and into the dosing side 146 of the piston. This air flushes any remaining release agent within the dosing side of the piston head 120, and any release agent within the fluid output conduit 160 and the spray head conduit 164, outwardly through nozzles 76a-76f of the release agent spray manifolds 72a, 72b. The dosing unit controller 174 typically flushes the spray head conduit 164 for a predetermined time. While the spray head conduit 164 is being flushed, the high pressure two output valve 104 continues to provide air through spray manifold output 108 to the release agent spray manifolds 72a, 72b.

After the mold agent flushing step 254, the spray subroutine 214 advances to step 256. At step 256, the dosing device 60 sprays air through blow-off nozzles 86a-86d by switching the dosing device air feed valve 112 to provide air through high pressure blow-off line 106 to the blow-off nozzles. Blow-off continues for a predetermined time.

Meanwhile during step 256, or afterward at step 258, the unit controller 174 switches the mold release 3-way valve 156 to close the path to spray head conduit 164 while opening the path from mold release conduit 154 to fluid output 160.

At release agent load recovery step 258, the path from the mold release storage container 150 is open to the dosing side 146 of the release agent as set forth above. At the same time, dosing device air feed valve 112 is closed. The air feed valve 112, however, includes a bleed valve 113 that enables air in the cylinder 118 on the driving side of the piston head to evacuate from the air feed conduit 114. As the mold release agent enters the dosing side 146 of the piston, the piston head 120 and the piston shaft 122 move leftwardly from the position shown in FIG. 3 toward a loaded position.

At step 260, the dosing unit controller 174 senses if the mold release full switch 132 is on. If not, the dosing unit controller 174 returns to step 258. When the piston stop 124 is alignment with the mold release full switch 132 at decision step 260, the dosing unit controller 174 advances to step 262.

At step 262, at least the mold release 3-way valve closes to maintain the mold release agent in the dosing side 146 of the dosing quantity control unit 116.

The above spray subroutine 214 enables an exact quantity of release agent to be loaded on the dosing side 146 of the piston head 120. Further, by flushing the fluid output and spray head conduit line 164 with air, all of the release agent provided in the dosing side 146 of the cylinder is applied to mold surfaces of mold elements 92, 94 through the nozzles 76a-76f.

The immediate application of force by the piston to the dose at the beginning of a mold release spray cycle results in essentially immediate output of a large quantity of the dose of mold release agent. As compared to the known system discussed above, the immediate output results in a shorter time period for the application of a predetermined amount of mold release agent.

Moreover, a force applied to output the dose from the dose quantity control unit to begin spraying, generally has a force greater than the force of the pressurized air being provided to spray manifolds 72a, 72b at least for a portion of the time period that the mold release agent is applied to a mold.

Further, the application of force to the dose results in a more uniform application of the mold release agent. Thus no output or less output of air by the blow-off nozzles 86a, 86d is necessary.

### Spray System Set-up

Before operating the spray system 10, mold release volume adjustment 128 is moved by rotating adjustment element 130 to vary the length of the stroke of the piston by limiting movement of the piston shaft 122. Mold release full switch 132 typically moves in correspondence with the mold release volume adjustment 128 so that the position of the piston shaft 122 is detected when the dosing side 140 of the cylinder 118 is completely filled with mold release agent.

Dials 80 are provided to adjust the valves 82a-82f to control the quantity of mold release agent from each nozzle 76a-76f.

### Alternatives

While FIG. 3 shows the dosing quantity control unit 116 as a piston arrangement, other precision dosing quantity embodiments are contemplated.

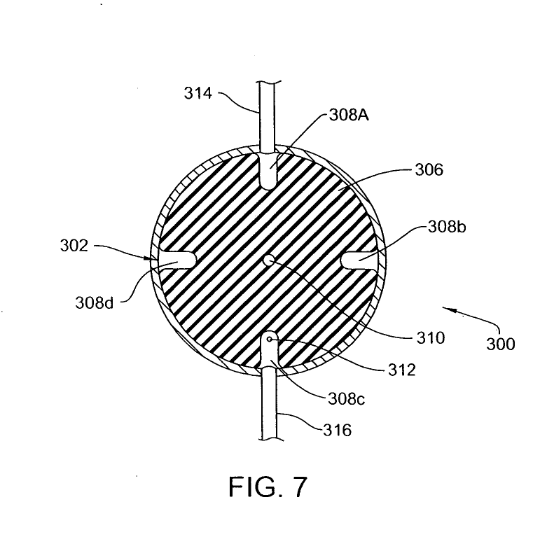

In one embodiment, a rotating dosing quantity metering device 300 shown in the cross-sectional view of FIG. 7 includes a cylinder including a cylindrical wall 302. Within the cylinder is a removable rotating mold release quantifying element 306. The quantifying element 306 includes a plurality of symmetrically spaced dosing compartments 308A-308D that open radially outwardly toward the cylindrical wall.

The quantity metering device 300 includes a mold release agent air drive aperture 312 illustrated at dosing compartment 308C for forcing release agent out of the dosing compartment 308C and into a mold release output line 316.

A bleed value is disposed within the cylinder adjacent an opening in the wall connected to a mold release input line 314. The bleed valve permits air removal from the dosing compartment 308A when mold release agent is forced into the compartment from the mold release input line 314. Drive shaft 310 is provided for rotating the mold release quantifying element 306.

In operation, the mold release quantifying element 306 rotates to a position whereat empty dosing compartment 308A is filled with mold release agent while mold release agent is being removed from compartment 308C by air provided from aperture 312. The mold release agent travels through mold release output line 316 to spray manifolds.

In one embodiment a drive device, such as a servomotor, is provided to move the piston head 122 of the dosing quantity control unit 116. In such an embodiment, the dosing unit controller 174 maintains the position of the piston head 122, and full switch and dispensed switch 132, 134 are not necessary. Further adjustment of the predetermined amount of release agent for each dose is accomplished by the dosing unit controller 174 controlling the servomotor.

In another embodiment, the shaft 310 of the quantity metering device 300 in FIG. 7 is driven by a drive device, such as a servomotor.

Although particular preferred embodiments of the invention have been disclosed in detail for illustrative purposes, it will be recognized that variations or modifications of the disclosed apparatus, including the rearrangement of parts, lie within the scope of the present invention.

What is claimed is:

1. A method for applying mold release agent to a surface of a mold, comprising the steps of:
providing a spray system including a mold release source and a dosing device having a dosing quantity control unit;
isolating an individual dose of mold release agent having a predetermined volume in the dosing quantity control unit; and
outputting the individual dose of mold release agent from the dosing quantity control unit through a spray nozzle to at least one surface of a mold.

2. The method according to claim 1, including the step of refilling the dosing quantity control unit with an individual dose of mold release agent having the predetermined volume.

3. The method according to claim 2, wherein the step of outputting the individual dose of mold release agent through the spray nozzle includes providing the dose of mold release agent from the dosing quantity control unit through a valve and a conduit to a spray manifold having the at least one nozzle connected thereto.

4. The method according to claim 3, including the step of:
providing pressurized gas through a gas conduit to the at least one spray manifold,
wherein the dose of mold release agent and the gas combine in the at least one spray manifold and are output from the at least one nozzle as is a mist of mold release agent and gas.

5. The method according to claim 4, including the step of: after the entire mold release agent is essentially removed from the quantity control unit, flushing any remaining mold release agent out of the spray system by providing pressurized gas to the dosing quantity control unit through the valve and the conduit to the spray manifold and the at least one nozzle connected thereto.

6. The method of claim 1, including the steps of:
stopping the application of mold release agent to the at least one mold surface; and
applying gas to the at least one surface of the mold through at least one blow-off nozzle.

7. The method according to claim 1, including the step of selecting a predetermined volume of mold release agent for each individual dose of the dosing quantity control unit.

8. The method according to claim 1, wherein the dosing quantity control unit comprises a cylinder and a piston shaft connected to a piston head disposed therein, the side of the piston head away from the piston shaft defining a dosing side for receiving the individual dose of mold release agent, and
wherein the step of outputting the individual dose of mold release agent through a spray nozzle to at least one surface of a mold comprises:
applying a force to the dose with the piston head to output the mold release agent; and
after travel of the piston head to a dose dispensed position, applying pressurized gas to the dosing side of the piston head to output any mold release agent remaining within the dosing quantity unit.

9. A method for applying mold release agent to a surface of a mold, comprising the steps of:
providing a spray system including a mold release source and a dosing device having a dosing quantity control unit;
applying mold release agent to at least one surface of a mold by outputting the mold release agent from the dosing quantity control unit through a conduit and a spray nozzle; and
after the entire mold release agent is essentially removed from the quantity control unit, flushing remaining mold release agent out of the spray system by providing pressurized gas through the dosing quantity control unit and the conduit to the at least one spray nozzle.

10. The method according to claim 9, including the step of isolating an individual dose of mold release agent having a predetermined volume in the dosing quantity control unit.

11. The method according to claim 10, wherein the at least one nozzle comprises one of a plurality of space nozzles, the method including the steps of:
selecting a predetermined volume of mold release agent for each individual dose of the dosing quantity unit; and
adjusting separate valves provided for each of the spray nozzles to selectively control the output of release agent for each of the spray nozzles.

12. The method according to claim 9, wherein a spray manifold is connected between the conduit and the at least one spray nozzle, and the method includes the step of providing pressurized gas through a gas conduit to the at least one spray manifold so that the mold release agent and the gas combine in the at least one spray manifold and are output from the at least one nozzle as a mist of mold release agent and gas.

13. The method according to claim 9, including the step of refilling the dosing quantity control unit with mold release agent having a predetermined volume.

14. A spray system for applying a predetermined quantity of a release agent onto a surface of a mold, comprising:
a frame member;
a dosing device having a dosing quantity control unit for isolating an individual dose of mold release agent having a predetermined volume;
a mold release source for providing mold release agent to the dosing quantity control unit;
a spray head mounted to the frame member and including at least one spray manifold;
a conduit connecting the dosing device to the at least one spray manifold; and
at least one spray nozzle connected to the spray manifold.

15. The spray system according to claim 14, including a dosing unit controller for controlling the dosing device to provide a force to the individual dose in the dosing quantity control unit so that the dose is output to the spray manifold via the conduit and then output from the at least one spray nozzle to a surface of a mold.

16. The spray system according to claim 15, wherein the dosing unit controller is configured to control a valve for providing pressurized gas to the dosing quantity control unit to flush the spray system by forcing any mold release agent remaining in the dosing quantity control unit through the conduit and through the at least one manifold for output by the at least one spray nozzle.

17. The spray system according to claim 14, wherein the dosing device is mounted to the frame member.

18. The spray system according to claim 14, wherein the spray head is movable linearly upwardly and downwardly relative to the frame member.

19. The spray system according to claim 14, wherein the dosing quantity control unit comprises a cylinder enclosing a piston head and a piston shaft, the cylinder including an output on a dosing side of the piston head for receiving mold release agent from the mold release source.

20. The spray system according to claim 19, comprising a three way valve including 1) a first valve position providing a first flow path for enabling mold release agent to enter the dosing side of the piston head, 2) a second valve closed position preventing movement of air or release agent from the dosing side of the piston head, and 3) a third valve position providing a second flow path for enabling mold release agent to enter the conduit connected to the at least one spray manifold.
